(19) United States
(12) Patent Application Publication
(10) Pub. No.: US 2009/0176078 A1
(43) Pub. Date: Jul. 9, 2009

(54) METHOD OF REDUCING THE AERODYNAMIC NOISE GENERATED BY AN AIRCRAFT UNDERCARRIAGE

(75) Inventors: CHRISTELLE SEROR, TOURNEFUILLE (FR); YANN GOERGER, LA CHAPELLE SURERDRE (FR)

Correspondence Address: MCCORMICK, PAULDING & HUBER LLP, CITY PLACE II, 185 ASYLUM STREET, HARTFORD, CT, 06103, US

(73) Assignee: MESSIER-DOWTY SA, VELIZY VILLACOUBLAY (FR)

(21) Appl. No.: 12/062,910

(22) Filed: Apr. 4, 2008

(30) Foreign Application Priority Data
Apr. 6, 2007 (FR) 07 02578

(51) Int. Cl. B32B 7/02

(52) U.S. Cl. 428/218

(57) ABSTRACT

A method and apparatus for reducing the noise generated by an aircraft undercarriage when the aircraft is flying and the undercarriage is deployed, includes coating at least a portion of a structural element of the undercarriage in a material that is of lower density than the material of the structural element in order to give this portion an aerodynamic shape suitable for smoothing a stream of air flowing around the portion.

### CROSS-REFERENCE TO RELATED APPLICATION

This application is entitled to the benefit of and incorporates by reference essential subject matter disclosed in French Patent Application No. 07 02578 filed on Apr. 6, 2007.

1. Field of the Invention

The invention relates to a method of reducing the aerodynamic noise generated by an aircraft undercarriage.

2. Background of the Invention

It is known that during landing, the deployed landing gear of an aircraft can contribute significantly to the aerodynamic noise generated by the aircraft.

Proposals have been made to place fairings on undercarriages for the purpose of deflecting the flow of air around portions that are liable to generate noise, e.g. cavities. Such fairings then act as deflectors and they may be made of metal or of composite material.

Such fairings raise various problems. Firstly it is appropriate to provide attachment points on the structural elements of an undercarriage, which attachment points are dedicated to securing the fairings. In addition, the fairings must be compatible with the movements involved in raising the undercarriage, and that can be complex to achieve. Finally, the fairings contribute to increasing the weight of the undercarriage.

Such fairings are illustrated by the following documents: EP 0 846 540; U.S. Pat. No. 1,333,630; and WO 2004/089742.

Proposals have also been made to revise the design of structural elements in order to eliminate any cavity or hollow that might generate noise. Although that can be effective in terms of reducing noise, it nevertheless leads to a significant increase in the weight of the structural part which makes that technique inapplicable for large elements such as side braces, leg struts,.

### OBJECT OF THE INVENTION

An object of the invention is to provide a novel method of reducing the disturbance of air around the elements of an undercarriage that runs the risk of generating noise.

### BRIEF DESCRIPTION OF THE INVENTION

The invention provides a method of reducing the noise generated by an aircraft undercarriage when the aircraft is flying and the undercarriage is deployed, the method consisting in coating at least a portion of a structural element of the undercarriage in a material that is of lower density than the material of the structural element in order to give said portion an aerodynamic shape suitable for smoothing a stream of air flowing around said portion.

Thus, the structural element is unchanged and therefore remains optimized from the points of view of weight and of ability to withstand forces. It is covered in a lightweight material, e.g. high density polyurethane foam, giving the structural element a smooth shape suitable for reducing the generation of turbulence and disturbances in the flow of air, thereby reducing the emission of noise. Thus, at the cost of a limited increase in weight, the structure of the undercarriage is preserved, while giving its structural elements shapes that are favorable from the acoustic point of view.

### BRIEF DESCRIPTION OF THE DRAWINGS

The invention can be better understood in the light of the following description with reference to the figures of the accompanying drawings, in which:

FIG. 1 is a perspective view of an aircraft undercarriage that is itself known;

FIG. 2 is a section view on line II-II of FIG. 1;

FIG. 3 is a section view on line III-III of FIG. 1;

FIG. 4 is a section view on line IV-IV of FIG. 1; and

FIG. 5 is a perspective view of a prior art side brace arm, and of the same arm after implementing the method of the invention.

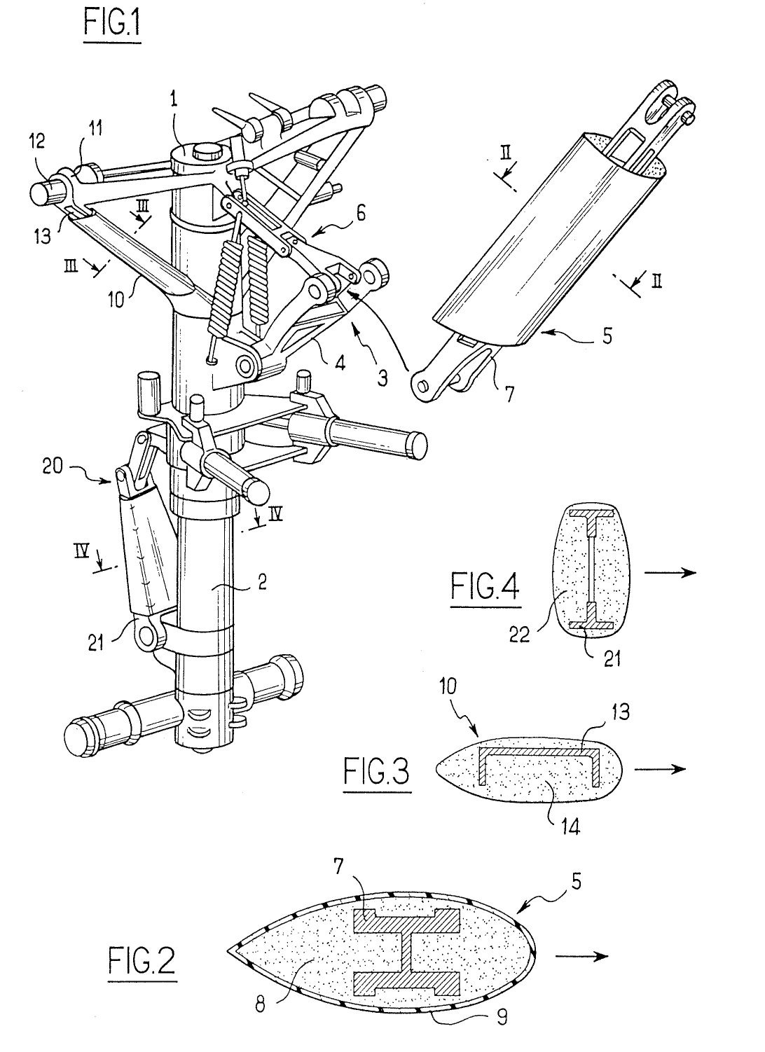

In each of FIGS. 2 to 4, an arrow specifies the direction of forward advance for the aircraft.

### DETAILED DESCRIPTION OF THE INVENTION

With reference to FIG. 1, the undercarriage shown comprises a strut 1 in which a rod 2 is mounted to slide telescopically. The undercarriage is held in the deployed position, as shown here, by means of a brace 3 comprising two hinged-together arms, namely a bottom arm 4 hinged to the strut 1 and a top arm 5 hinged to the aircraft. The arms 4 and 5 are held in alignment by a stabilizer mechanism 6.

A first application of the invention relates to the top arm 5 of the brace. As can be seen in FIG. 2, it comprises a structural portion 7 made of metal with its main portion having an I-shaped section, with the flanges of the I-shape themselves being recessed. The structural portion thus includes numerous hollows and cavities that might generate noise. According to the invention, the top arm 5 is coated in a lightweight material 8, specifically high density polyurethane foam, to give the top arm 5 a shape that is smooth and aerodynamic. The entire shape is itself covered in a covering 9, specifically made by draping preimpregnated glass fiber fabric that is polymerized while cold, serving to improve the surface state of the deflector as constituted in this way and also serving to protect the lightweight material 8.

As a result, the flow of air around the top arm 5 is made more smoother, thereby contributing to decreasing the noise generated by the top arm 5.

Another application of the invention is shown in FIG. 3. This shows one of the arms 10 of the strut 1, visible in FIG. 1, that extends from an eye 11 for receiving of the pins 12 hinging the strut 1 to the structure, to the cylinder of the strut 1 receiving the rod 2. The arm has a structural portion 13 that is mainly of channel section, and optimized from the points of view of weight and of transmitting forces. The structural portion 13 is coated in a lightweight material, in this case an elastomer material to give the arm a smooth shape that is much more favorable from the acoustic point of view.

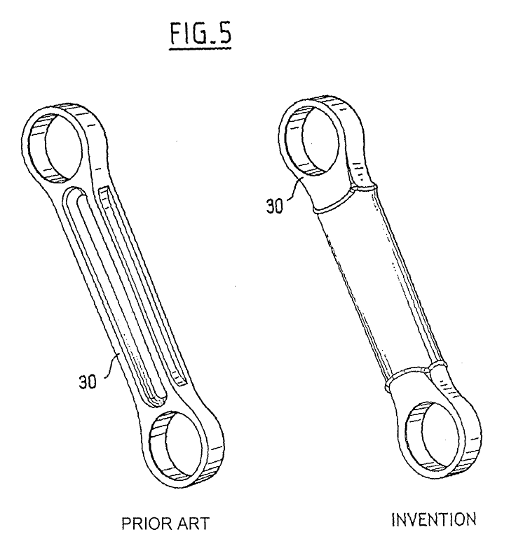

Still another application is shown in FIG. 4 relating to the bottom branch 21 of a scissors linkage 20 connecting the rod 20 to the strut 1 so as to prevent the rod 2 from turning in the strut 1, while still being free to slide therein. The bottom branch 21 is mainly constituted by a section comprising a web (made lighter by orifices) and two flanges. The bottom branch 21 is covered in a lightweight material 22, in this case an elastomer material, so as to give the bottom branch 21 a smooth shape that is favorable from the acoustic point of view.

A final application is shown in FIG. 5. This relates to an arm 30 of an undercarriage brace. On the left-hand side of the figure, the arm 30 can be seen with the appearance it has before being coated. On the right-hand side of the figure, the arm can be seen after it has been coated in accordance with the invention in a polyurethane foam. It can immediately be seen that the hollows and cavities in the arm 30 are filled in, and that the arm now presents an outside shape that is smooth and suitable for minimizing aerodynamic disturbances, and thus for reducing the associated noise.

Thus, while remaining optimized from points of view of weight and ability to withstand forces, the structural element as coated in this way has acquired an outside shape that is suitable for reducing aerodynamic noise. In particular, the hollows and the cavities that are liable to give rise to aerodynamic disturbances are filled in. Preferably, the coating is given a smooth shape suitable for reducing the noise generated by the structural element, for example a shape that is circular, oval, or tapering in section.

In order to minimize the increase in weight, it is preferable to select a coating material that is less dense than the material constituting the structural element, but that nevertheless possesses sufficient strength to constitute fairing that is strong. Mention has been made of polyurethane and elastomer foams, but other similar materials could also be used.

The coating made in this way serves not only to reduce noise, but also to protect the structural element from impacts from stones or tools, and also from oxidation. Nevertheless, it should be observed that the coating made in this way does not perform any structural function.

The invention is not limited to the above description, and on the contrary it covers any variant coming within the ambit defined by the claims.

In particular, although the invention is shown in application to an aircraft nosewheel undercarriage, it should be understood that the invention is also applicable to a main undercarriage, and in particular can be applied to the strut, the brace elements, the rocker beam, and any other structural element having hollows and cavities or liable to generate aerodynamic noise.

It should be observed that coating in accordance with the invention can be performed on the structural elements of undercarriages that are already in service, e.g. when carrying out maintenance thereon. It is thus possible immediately to obtain a significant reduction in the aerodynamic noise generated by equipment that is already in service, and to do so at little cost.

What is claimed is:

1. A method of reducing the noise generated by an aircraft undercarriage when the aircraft is flying and the undercarriage is deployed, the method consisting in coating at least a portion of a structural element of the undercarriage in a material that is of lower density than the material of the structural element in order to give said portion an aerodynamic shape suitable for smoothing a stream of air flowing around said portion.

2. A method according to claim 1, in which the structural element is coated with the help of a material of lower density than the material constituting the structural element.

3. A method according to claim 1, in which the coated portion is covered in a thin covering.
